(19) United States
(12) Patent Application Publication
(10) Pub. No.: US 2004/0263941 A1
(43) Pub. Date: Dec. 30, 2004

(54) Single fiber connector extension for transmission of digital video data

(76) Inventors: Chung-Chien Chen, Rowland Heights, CA (US); Trong-Huang Lee, Walnut, CA (US); Xiaoming Liu, La Palma, CA (US); Keyth M. Smith, Mission Hills, CA (US); Shyue-Jong Yang, Walnut, CA (US)

Correspondence Address: ELLIOTT N. KRAMSKY, Esq., Suite 400, 5850 Canoga Avenue, Woodland Hills, CA, 91367, US

(21) Appl. No.: 10/603,005

(22) Filed: Jun. 24, 2003

(51) Int. Cl. G02F 1/03; G02F 1/07

(52) U.S. Cl. 359/245

(57) ABSTRACT

Apparatus for extending the range of effective communication of high speed digital video data between remote devices, such as a microprocessor and a flat panel display, having associated connectors. A fiber optic cable comprising a single optical fiber provides a shared optical path for signal transmission between the connectors. Electrooptic converters are provided for converting the electrical signals sent and received by each of the connectors to optical form for transmission over the single-fiber cable.

### BACKGROUND

1. Field of the Invention

The present invention relates to apparatus for interfacing a digital full color video signal source with a display. More particularly, this invention pertains to apparatus for extending the range of transmission of digital video signals over a single optical fiber between such a source and a display.

2. Description of the Prior Art

Microprocessors and other devices that generate digital signals are commonly employed in conjunction with remote peripheral devices. Often such peripherals are required for providing inputs or outputs to be processed. Examples of input peripherals include keyboards and mouses while output peripherals include printers and displays.

Peripherals are commonly linked to the microprocessor by means of cables for engaging particularized microprocessor ports. The ports are configured to receive data output from a particular device that may or not require processing or buffering prior to processing within the microprocessor. Alternatively, ports may configure data generated within the microprocessor so that it can be utilized by, and thereby activate, the peripheral device.

Convenience of use and other factors often make it desirable to locate peripheral devices some distance from the microprocessor. Peripherals that operate with relatively low speed digital signal outputs and inputs are able to tolerate transmission of digital signals over relatively long distances over relatively-lossy cables of copper without significant degradation of function.

The situation is quite different for peripherals that receive digital signals for generating video images at a remote display. The transmission of video inputs in the form of digital signals is required for such peripherals as flat panel displays. Such displays, which employ a pixel matrix of liquid crystal material, gas plasma cells or LED arrays, differ from those that generate images by means of an analog signal-driven cathode ray tube (CRT) which employs an electron gun that is scanned across a phosphor screen to generate an image. Such CRT-driven displays provide images that are subject to flicker and consume significantly greater power than flat panel displays.

Data rates in the range of hundreds of megabits per second are required to drive displays of the flat panel type. While such rates may be reduced by data compression, this is undesirable or unacceptable for many applications (e.g. head-up cockpit display) as it prevents real time display of data. Further, real time transmission of digital video data is required by Digital Visual Interface revision 1.0 promulgated Apr. 2, 1999 by the Digital Display Working Group (hereinafter referred to as “the DVI standard”).

Prior art transmissions of high speed digital video between computer and display have generally taken place over a DVI standard-compatible cable of copper conductors and have been found to degrade such data significantly as the length of the copper cable is increased. For example, it has been recognized that the maximum distance that can be transmitted by copper at HDTV (1920×1080 pixels) resolution without suffering serious degradation in video quality does not exceed ten (10) meters. Such a limit has also been found to exist for the common “RGB” cable in which digital-to-analog and analog-to-digital conversions take place at either end with the signal transmitted therebetween in analog form along a cable of copper conductors. Such limitation upon the physical distance separating computer from flat panel display places often-significant design limitations upon numerous applications and potential applications (e.g. the routing of cabling within an aircraft).

### SUMMARY OF THE INVENTION

The preceding and other shortcomings of the prior art are addressed by the present invention that provides, in a first aspect, apparatus for generating video images on a display device arranged in accordance with a digital video standard. Such apparatus includes a processor for generating a plurality of digital electrical signals, including a first transmission protocol signal, in accordance with the predetermined video standard.

A first connector, including a plurality of pins, is provided for receiving and directing each of the digital electrical signals to a predetermined pin and for receiving a second digital electrical transmission protocol signal at a predetermined pin. A second connector includes a plurality of pins arranged to receive each of the digital electrical signals, direct each of such signals to a predetermined portion of an input port of the display device, receive the second digital electrical transmission protocol signal from the display device and direct the transmission protocol signal to a predetermined pin of the second connector.

An electrical-to-optical converter circuit receives the plurality of digital electrical signals and generates a plurality of digital optical signals in response. The converter also receives a digital optical signal and generates the second digital electrical transmission protocol signal in response. An optical-to-electrical converter circuit receives the digital optical signals and converts them to the plurality of digital electrical signals and converts the second digital electrical transmission protocol signal to a digital optical signal.

An optical cable is in optical communication with the electrical-to-optical converter circuit and with the optical-to-electrical converter circuit. The optical cable includes a single optical fiber for transmitting the optical signals between the electrical-to-optical converter and the optical-to-electrical converter.

In a second aspect, the invention provides apparatus for communication of a bidirectional digital electrical signal, comprising sequential forward and reverse transmissions, between a bidirectional port of a first device and a bidirectional port of a second device and an associated electrical clock signal between a clock port of the first device and a clock port of the second device. The first and second devices are remote from one another.

Such apparatus includes an electrical-to-optical converter circuit for receiving a forward digital electrical signal and the electrical clock signal and generating a forward digital optical signal in response and for receiving a reverse digital optical signal and generating a reverse digital electrical signal in response. An optical-to-electrical converter circuit is provided for receiving the forward digital optical signal and converting it to the forward digital electrical signal and the electrical clock signal while converting the reverse digital electrical signal to the reverse digital optical signal.

An optical cable is in optical communication with the electrical-to-optical converter and with the optical-to-electrical converter. Such optical cable includes a single optical fiber for transmitting the optical signals between the electrical-to-optical converter and the optical-to-electrical converter.

The foregoing and other features of the invention will become further apparent from the detailed description that follows. Such description is accompanied by a set of drawing figures. Numerals of the drawing figures, corresponding to those of the written description, point to the features of the invention. Like numerals of the drawing figures and written text point to like features of the invention throughout.

### BRIEF DESCRIPTION OF THE DRAWINGS

FIGS. 1(a) and 1(b) illustrate real time digital video display systems in accordance with the prior art and the invention respectively;

FIG. 2 is a block diagram of the transmitter module of a fiber optic real time digital video extension module in accordance with the invention;

FIG. 3 is a block diagram of the receiver module of a fiber optic real time digital video extension module in accordance with the invention;

FIGS. 4(a) through 4(f) are a series of timing diagrams for illustrating the electrical multiplexing of DDC_Data_sent and DDC_Clock signals in a transmitter module of a fiber optic real time digital video extension module in accordance with the invention;

FIGS. 5(a) and 5(b) are schematic diagrams of an optical multiplexer of an electrooptic transmitter and an optical demultiplexer of an electrooptic receiver respectively a fiber optic real time digital video extension module in accordance with the invention;

FIG. 6 is a schematic diagram of a directional logic circuit in accordance with the invention; and

FIGS. 7(a) and 7(b) are timing diagrams for illustrating forward and reverse transmission components of a bidirectional transmission protocol signal DDC_Data in accordance with the DVI standard.

### DETAILED DESCRIPTION OF THE PREFERRED EMBODIMENT

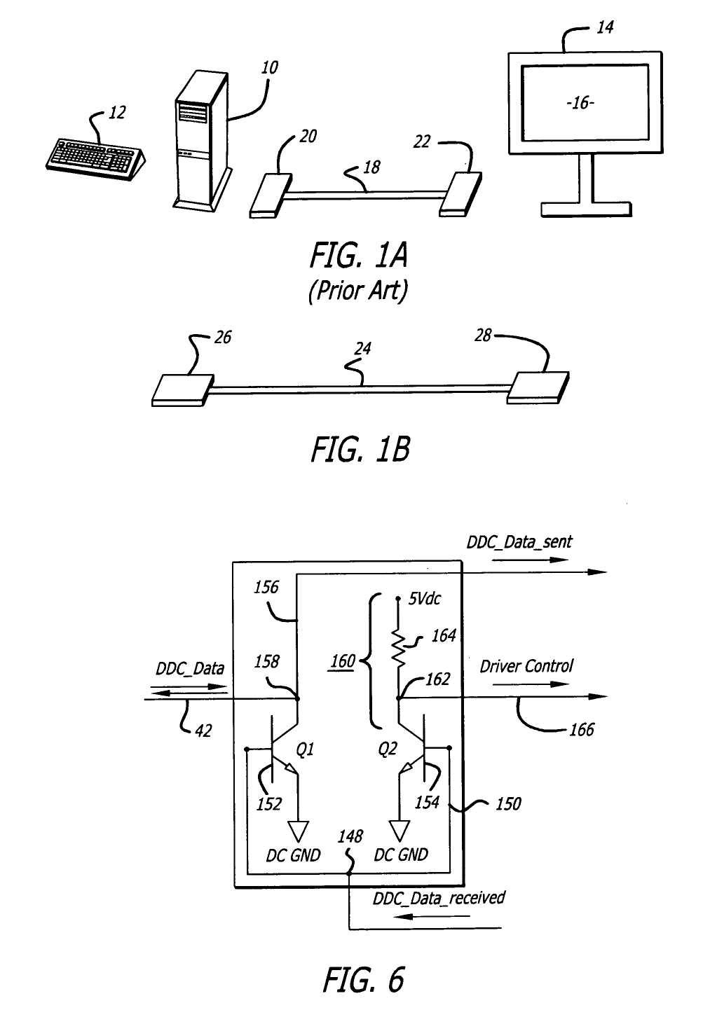

FIGS. 1(a) and 1(b) illustrate real time digital video display systems in accordance with the prior art and the invention, respectively. Each of the systems is provided for high speed transmission of digital data output, for example, by a processor 10. The processor 10 comprises a device for generating, receiving and processing digital signals and may include but is not limited to, a microprocessor, video processor or the like. The data can be generated in response to having inputs provided, for example, by means of a keyboard 12. A display device 14 is arranged for generating corresponding video images on a screen 16. In addition to the high speed video data provided to the display device 14, relatively low speed data must be exchanged between the processor 10 and the display device 14 to assure that the data transfer process occurs properly. Such low speed data transmission permits the processor 10 to learn the identity of the display device 14 to thereby configure the video data output accordingly and in accordance with the peculiarities of the display device 14. Additionally, the microprocessor 10 must be informed of changes in either the identity or status of the display device 14, error messages and completion data, etc. The signal transmissions required of both processor and display device manufacturers to assure interoperability between equipment of different origins are regularized by means of standards established by industry organizations. For example, communication between personal computers and flat panel displays is regulated by the DVI standard. For purposes of illustration only, the discussion of the invention will proceed in accordance with such standard although it will be recognized that the teachings of this invention are not limited to interactions between a processor and a display device nor to communications in accordance with the DVI standard.

Both high speed digital video and relatively low speed digital transmission protocol data are transmitted between processor 10 and display device 14 over a common transmission link. In the prior art, such transmission (without conversion to analog form) has typically taken place over a cable 18 comprising a plurality of copper conductors as illustrated in FIG. 1(a). The cable 18 is terminated at either end by 24-pin DVI connectors 20 and 22. The DVI connector 20 comprises a hardware arrangement for receiving digitized video data output from the processor 10, which includes a video card that processes inputs from the processor 10 into proper digitized video signals, and directing such digitized video signals to pins whose locations are determined in accordance with the DVI standard. Conversely the DVI connector 22 is arranged to receive the outputs from the DVI connector 20 at predetermined pins and to direct the signals to standardized pin locations that communicate with an input port of the display device 14 whereby such input signals may be properly processed to generate images on the screen 16 of the display device 14. Additionally, it will be seen that each of the DVI connectors 20 and 22 includes a pin adapted to receive and transmit a bidirectional signal that contains transmission protocol information in digital form (along with an accompanying clock signal).

FIG. 1(b) illustrates a system for digital transmission of real time video information between the processor 10 and the display device 14 in accordance with the invention that significantly extends the effective operational separation distance therebetween. Such device comprises a single-fiber cable 24 having an electrooptic transmitter 26 at one end and an electrooptic receiver 28 at the other end. As will be discussed below, the electrooptic transmitter 26 includes the DVI connector 20 while the electrooptic receiver 28 includes the DVI connector 22, each in combination with additional electrical-to-optical and optical-to-electrical converter circuitry, respectively, for rendering the standard-mandated digital signal exchange between processor 10 and display device 14 compatible with an optical fiber transmision medium. As a result, the range or separation distance between processor 10 and display device 14 is extended much beyond the approximately ten meter limitation of copper cable transmission. Transmission of signals in accordance with the DVI standard over 1000 meters has been observed with no noticeable degradation in video signal quality.

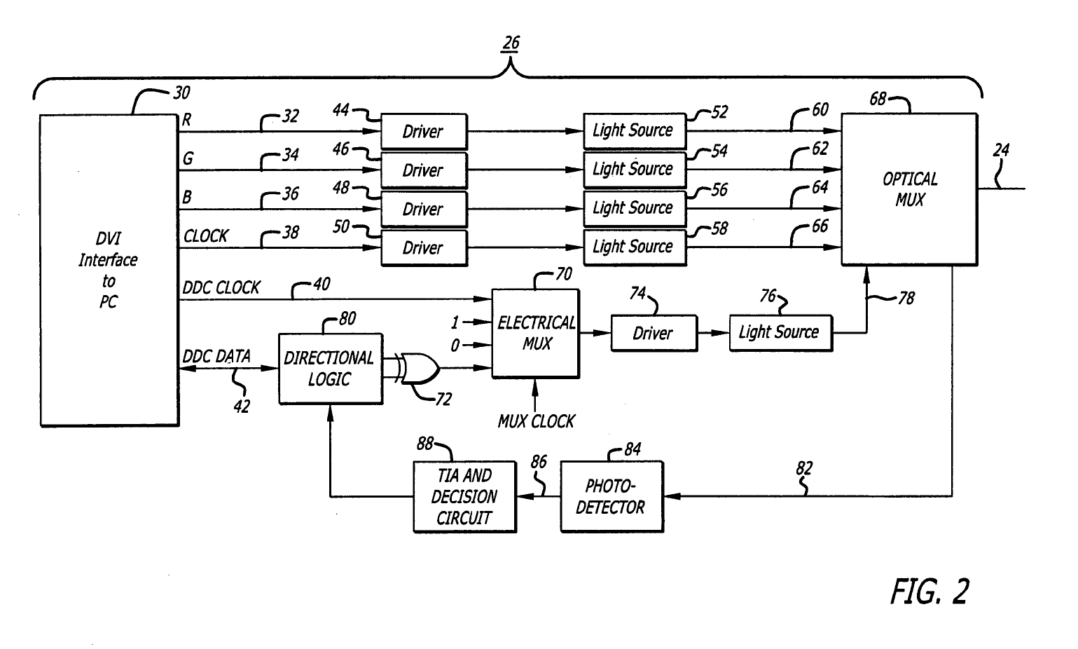

FIG. 2 is a block diagram of the electrooptic transmitter 26 of the invention. The transmitter 26 receives and converts electrical signals that have been formatted in accordance with the DVI standard for transmission to a display device 14 such as a flat panel display. The transmitter 26 incorporates a DVI connector 30 that is identical to the DVI connector 20 employed in prior art arrangements in conjunction with a copper cable.

The outputs of, and inputs to, the DVI connector 30, originating and received at both the processor 10 and the display device 14, are identical to those of the prior art arrangement that includes a copper cable of limited effective digital video signal transmission range. Unlike the prior art, digital video signal transmission takes place over the single-fiber cable 24 resulting in greatly-increased effective signal transmission range between the processor 10 and the display device 14. Such enhanced transmission range is accomplished by substituting a single-fiber cable for a cable of copper conductors in conjunction with associated apparatus that prepares the electrical signals received by and transmitted from the DVI connector 30 for “seamless” integration into the optical transmission system.

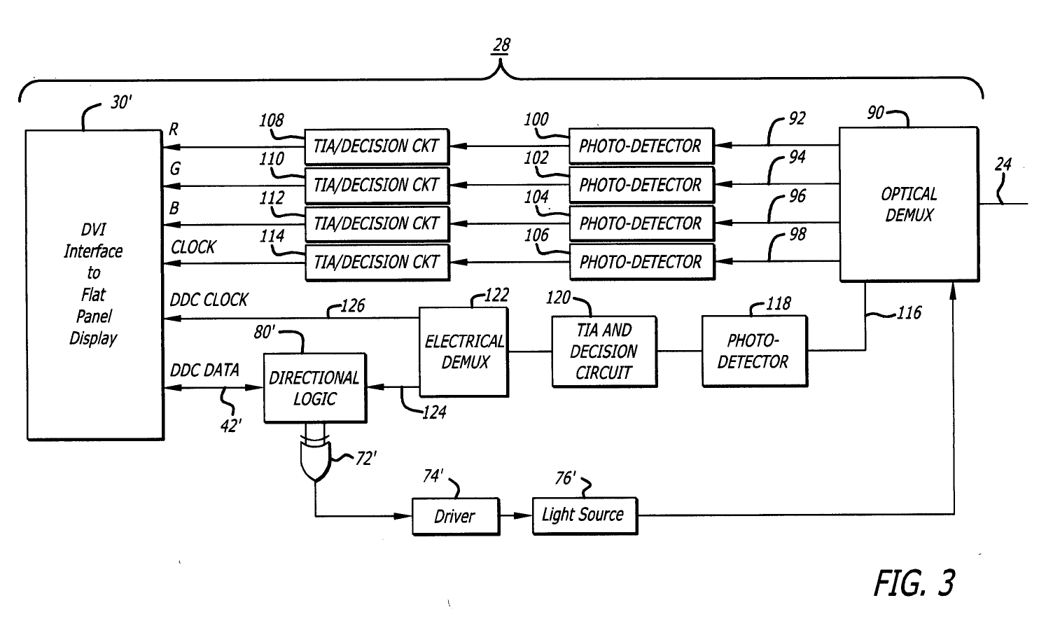

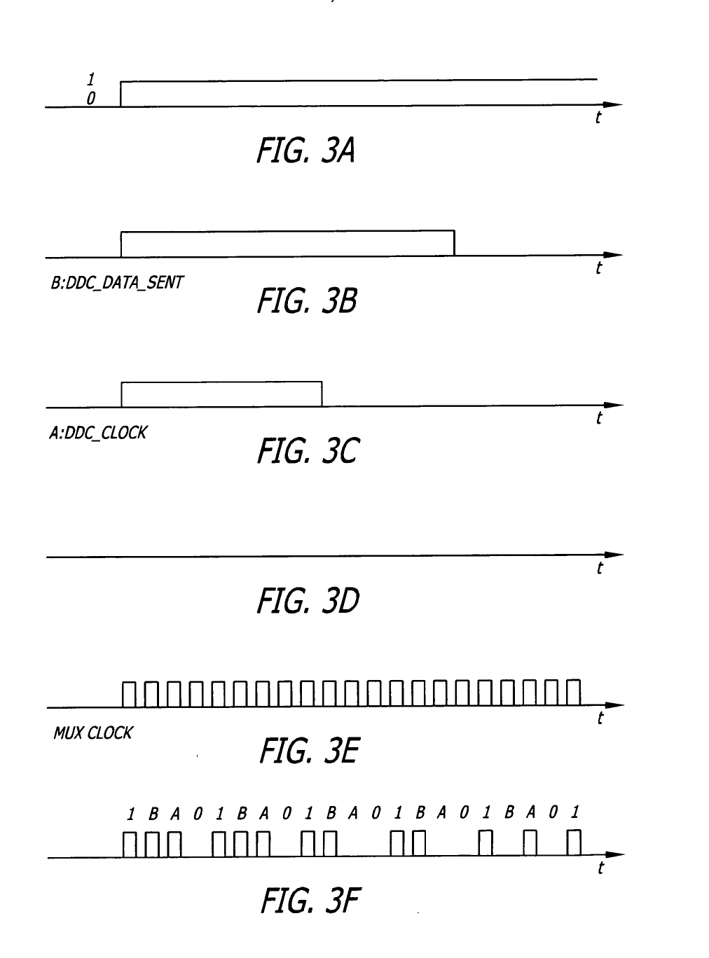

While proceeding through a discussion of the elements of the electrooptic transmitter 26, it should be kept in mind that the processes described in conjunction with the elements and arrangements of the transmitter 26 essentially take place in mirror image at the other end of the single-fiber cable 24 at the electrooptic receiver 28. Such an electrooptic receiver 28 is illustrated by the block diagram of FIG. 3. Just as in the case of the electrooptic transmitter 26, the receiver 28 includes a DVI connector 30′ conforming to an appropriate DVI standard that may be seen, for purposes of discussion, to be identical to the connector 22 employed in conjunction the copper cable 18 of the prior art. As such, apparatus is provided at the display device 14 end of a digital video signal transmission for conversion of the electrical signals output by and received at the DVI standard connector 30′ to and from optical mode. Accordingly, essentially identical technical hardware arrangements (with obvious transpositions of photodetectors for light sources in accordance with the directions of relative signal flows) are provided in the invention at each end of the single-fiber cable 24. For this reason, some elements of the electrooptic receiver 28 corresponding to those of the electrooptic transmitter 26 are indicated by primed numeral of the corresponding element of the transmitter 26.

Returning to FIG. 2, the DVI connector 30 receives data from the processor 10 containing information that formatted as electrical signals defining a full color transmission. Such signals are transferred from pins of the connector 30 that contact the port of the processor 10 to those that receive electrical conductors of the associated electrical-to-optical conversion circuitry. That is, the DVI connector 30 provides a “red information” signal on a first electrical conductor 32, a “green information” signal on a second electrical conductor 34, a “blue information” signal on a third electrical conductor 36 and a “pixel clock” signal on a fourth electrical conductor 38. (Note, frame synchronization information is included within one of the red, green or blue information signals.)

The DVI connector 30 additionally provides signals that are required by the applicable DVI standard for both enabling and regulating the effective communication of high speed digital video data from a processor 10 for display as images on a display device 14. A relatively low speed transmission protocol clock signal (“DDC_Clock”) that controls and synchronizes the transmission of such transmission protocol signals is provided on an electrical conductor 40.

The transmission protocol communication between the processor 10 and the display device 14 in accordance with the applicable DVI standard is sent and received on an electrical conductor 42 in communication with the appropriate pin of the connector 30. Such communication is two-way as, in accordance with the physical configuration of the DVI connector 30, it involves a single port that must accommodate transmissions both by and from both the processor 10 and the display device 14. The provision of two-way transmissions over a single electrical conductor involves merely the provision of signal headers and the like for identifying the direction of transmission. It will be seen that the present invention addresses the much more significant issues that arise when optical signal transmissions are involved.

Each of the signals output on the electrical conductors 32 through 42 comprises a transmission of digital data. The prior arrangement may be thought of as essentially the direct interconnection of a pair of DVI connectors through electrical connectors. In the invention, much greater separation is obtained between the two DVI connectors by interposing an optical transmission medium.

The conversion of the high speed digital video electrical signals output on the electrical conductors 32 through 38 is accomplished by applying such signals to drivers 44 through 50 arranged to trigger, and thereby modulate, light sources 52 through 58. The light sources, preferably laser diodes of the VCSEL type, are arranged to emit optical carrier signals of slightly different center wavelengths. The amount of center wavelength offset is chosen to match the center wavelengths of an optical CWDM (coarse wavelength division multiplexing) multiplexer module, discussed below. A representative, although by no means exclusive, set of center frequencies appropriate for the set of VCSEL light sources would be 773, 800, 825 and 850 nm. Such light sources provide the carriers of video information provided on the electrical conductors 32 through 38 for generating a frame of an image on the screen 16 of the display device 14. Such high speed digital optical signals are capable of greater than one kilometer transmission over optical fiber without significant degradation.

While representing an extremely significant increase in the range of transmission of high speed video signals, the range of transmission of signals over an optical medium will vary in accordance with the types of light sources and optical fiber employed. For example, the outputs of light sources of the VCSEL, LED or Fabry-Perot type can transmit high speed digital signals over a range of up to approximately 2 kilometers over multi-mode optical fiber. On the other hand, much greater ranges are possible when single mode fiber is employed. While light output from a LED cannot be coupled into single mode fiber, high speed digital signals output onto single mode fiber from a VCSEL light source may be transmitted up to approximately 10 kilometers and those output from a Fabry-Perot light source are capable of transmission up to approximately 50 kilometers. High speed digital signals output from a distributed feedback (DFB) laser light source onto single mode optical fiber may be transmitted up to approximately 100 kilometers.

The optical signals output from the light sources 52 through 58 are carried on optical fibers 60 through 66 respectively and are received at an optical multiplexer 68.

The digital electrical DDC_Clock signal transmitted along the electrical conductor 40 provides one input to an electrical multiplexer 70. The output of a logic gate 72 comprises the other input to the electrical multiplexer 70. The output of the electrical multiplexer 70 is applied to a driver 74 that actuates a light source 76 to provide an optical signal that is transmitted over an optical fiber 78. The light source 76 is preferably a LED arranged to output, for example, 1310 nm light rather than a VCSEL due to the much slower speed of the DDC_Clock and DDC_Data signals than the video information and video clock signals. It will be appreciated that the light source 76 is chosen so that its center frequency lies outside the band of center frequencies of the light sources 52 through 58.

The bidirectional digital transmission protocol signal carried on the electrical conductor 42 is split by means of a directional logic circuit 80 for transmission/receipt as two unidirectional signals along two separate circuit branches of the electrical-to-optical circuit. This reflects the fact that, while the DVI standard allows transmission of the DDC_Data transmission protocol signal in two directions over a single electrical conductor, the optical signals must be carried over separate circuit branches. That is, while a DDC_Data_sent signal will be seen to be multiplexed with the DDC_Clock signal and the combined signal applied in a forward direction to cause the light source 76, located in a first circuit branch, to be actuated by the driver 74, a DDC_Data_received signal communicated in the reverse direction is received at a transimpedance amplifier/decision circuit over a second branch that includes a photodetector. As such, separate paths or branches must exist, one for sending an optical signal from a first light source in one direction and another for receiving an optical signal emitted from a second light source (located within the electrooptic receiver) in the opposite direction to perform the required mimicking of a bidirectional electrical signal transmission (as required by the DVI standard) over a single electrical, conductor.

The directional logic circuit 80 serves to split and recombine a bidirectional electrical DDC_Data signal into two one-way signals containing transmission protocol information that communicate between the DVI connectors 30 (and, thus, the microprocessor 10) and 30′ (and the associated display device 14). By splitting the bidirectional DDC_Data signal into two one-way signals, the bi-directional signal communication of this information over the single-fiber cable 24 is facilitated. As the applicable DVI standard and existing DVI connectors 30 and 30′ are configured to receive DDC_Data at a single bidirectional port, it is essential that the fragmenting and reassembly of this bidirectional electrical signal be invisible to the DVI connectors 30 and 30′.

An electrical signal containing transmission protocol information, output from the DVI interface 30 onto the electrical conductor 42, continues and is applied to the logic gate 72 after passage through the directional logic circuit 80. It is EXCLUSIVE OR'ed at the logic gate 72 with a control signal, discussed below, that is internally generated at the directional logic circuit 80. The output of the logic gate 72 provides an electrical signal that is input to the electrical multiplexer 70. It will be seen later that the output of the logic gate 72 comprises the forward transmission protocol signal DDC_Data_sent. This signal is combined with the transmission protocol clock signal DDC_Clock at the electrical multiplexer 70. The serial combination of the two electrical signals into a single multiplexed electrical signal will be seen to eventually enable the optical transmission of all signals between the DVI connectors 30 and 30′ over a cable 24 that requires only a single optical fiber.

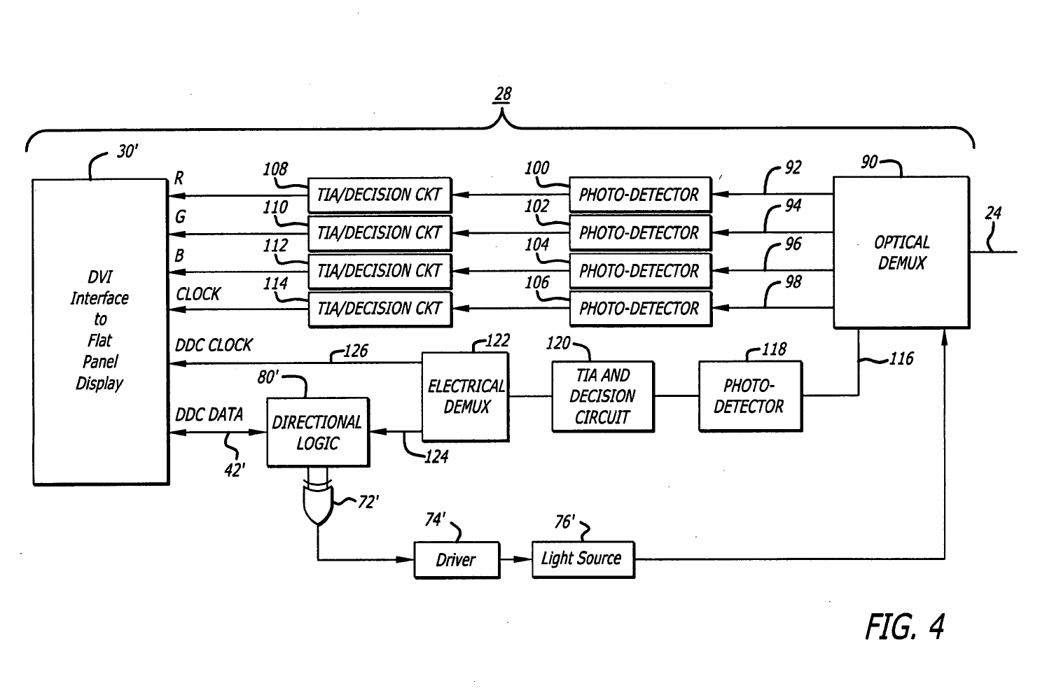

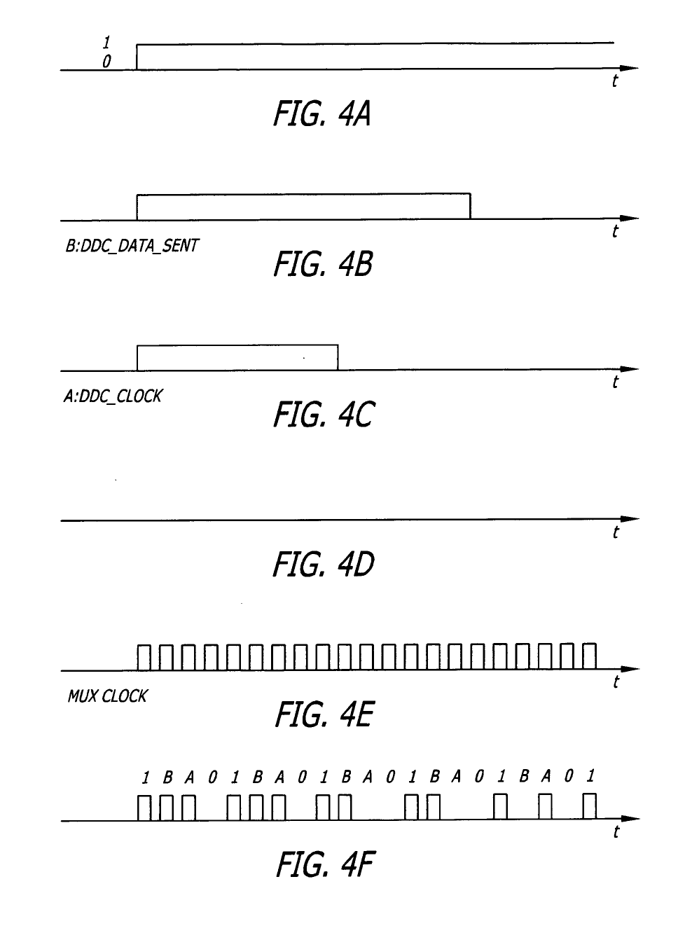

FIGS. 4(a) through 4(f) are a series of timing diagrams for illustrating the process of serial combination of the DDC_Data_sent and DDC_Clock signals into a single signal by means of the multiplexer 70. The DDC_Data_sent and DDC_Clock signals are applied to the multiplexer 70 as two parallel signals and emerge as a single signal defined by a series of framed, sequential signal samples. A beginning or stuffing header, illustrated in FIG. 4(a), is arbitrarily held at a high or l“ ” level while an end or stuffing header, illustrated in FIG. 4(d), is arbitrarily held at a low or “0” level.

The two headers define the limits of a frame of serial data comprising the DDC_Data-sent and DDC_Clock signals illustrated in FIGS. 4(b) and 4(c) respectively. The forward transmission protocol and protocol clock signals are multiplexed together by sequentially sampling the signals of FIGS. 4(a) through 4(d) at a rate determined by a multiplexer clock signal as illustrated in FIG. 4(e). The resultant combined signal output by the multiplexer 70 is illustrated in FIG. 4(f). As can be seen, the signal of FIG. 4(f) comprises a series of bits at the multiplexer clock rate arranged into blocks, each of which is framed by a beginning framing or stuffing bit of high or “1” level and an end bit of low or “0” level. Between each pair of framing bits is one bit that represents a sample of DDC_Data_sent and one bit that represents a sample of DDC_Clock, the samples of the two signals having been taken at two consecutive multiplexer clock pulses.

Returning to FIG. 2, the output of the electrical multiplexer 70, comprising the multiplexed DDC_Data_sent and DDC_Clock signals as described above, is applied to the driver 74 that, in turn, controls the light source 76 which, again may comprise a LED arranged to output 1310 nm light.

Incoming transmission protocol information in the form of a multiplexed optical digital signal is received at the optical multiplexer 68 wherein it is coupled to an optical fiber 82 and transmitted to a photodetector 84. The photodetector 84 generates an electrical signal in response that is transmitted on an electrical conductor 86 to a transimpedance amplifier/decision circuit 88 which converts the relatively small current generated by the photodetector 84 into a voltage that it then amplifies. Thereafter, the circuit 88 determines the state of the incoming signal as “0's” or “1's” by means of post amplifiers and comparators to generate a relatively low speed digital electrical transmission protocol signal DDC_Data_received for application to the directional logic circuit 80. As stated above, the directional logic circuit 80 is arranged to selectively block or permit passage of the incoming digital electrical transmission protocol signal to the DVI connector 30. The bidirectional transfer of transmission protocol information between the microprocessor 10 (and associated DVI connector 30) and the digital display device 14 (and associated DVI connector 30′) thereby takes place seamlessly over a much greater range than is possible in a prior art arrangement in accordance with FIG. 1(a).

Reviewing the arrangement of the electrooptic receiver 28 of FIG. 3, it will be understood that the incoming optical signal containing transmission protocol information received and transmitted over the optical fiber 82 was generated at a light source 76′ of the electrooptic receiver 28. Referring further to FIG. 3, it can be seen that the optical digital video signals generated at the light sources 52 through 58 of the electro-optic transmitter 26 are received over the single-fiber cable 24 at an optical demultiplexer 90 whereupon they are optically separated for transmission over optical fibers 92 through 98 that transmit the red, green, blue and clock digital video signals to photodetectors 100 through 106 to thereby generate corresponding electrical currents that are converted into high speed digital video electrical signals by transimpedance amplifier/decision logic circuits 108 through 114 respectively. The outputs of the transimpedance amplifier/decision logic circuits 108 through 114 are sent over electrical conductors whereby such high speed digital video signals, corresponding to the high speed electrical digital video signals output from the DVI connector 30 along the electrical conductors 32 through 38 of FIG. 2, are received at the appropriate ports of the DVI connector 30′.

A fiber 116 is optically coupled through the optical demultiplexer 90, as described below, to the single-fiber cable 24 that transports the digital optical signal output from the light source 76 of the electrooptic transmitter 26 which carries the serially-combined DDC_Data_sent and DDC_Clock information. Such digital optical signal is applied to a photodetector 118 for generating an electrical current that is converted into a digital electrical signal at a transimpedance amplifier/decision logic circuit 120. This is then transmitted, on an electrical conductor, to an electrical demultiplexer 122 that effectively reverses the process illustrated by the timing diagrams of FIGS. 4(a) through 4(f) to reconstitute and separate the DDC_Data_sent and DDC_Clock signals. The now-separate signals, DDC_Data_sent and DDC_Clock, are then output onto the electrical conductors 124 and 126 respectively. The DDC_Clock signal is thereby transmitted to the appropriate port of the DVI connector 30′. The DDC_Data_sent signal, on the other hand, is transmitted over the electrical conductor 124 to a directional logic circuit 80′ of the electrooptic receiver 28. The remainder of the circuitry of the electrooptic receiver 28 is indicated by primed numerals, indicating functional correspondences to elements of the electrooptic transmitter 26.

As mentioned above, costs associated with optical fiber usage are minimized in the present invention as the minimal amount of optical fiber is employed to transmit the signals between the electrooptic transmitter 26 and receiver 28. The transmission of optical signals carrying digital video and transmission protocol information over a single optical fiber is made possible by the incorporation of a number of features into the invention. A number of such features have already been discussed. These include: (1) the use of light sources 52 through 58 of distinct center frequencies to generate four separable optical digital signals of video information; (2) the use of light sources 76 and 76′ for carrying the DDC_Data_sent plus DDC_Clock and DDC_Data_received transmission protocol information of a fifth center optical frequency that is outside the optical frequency band of the light sources 52 through 58 which carry digital video information; and (3) the use of an electrical multiplexer 70 in the electrooptic transmitter 26 and an electrical demultiplexer 122 in the electrooptic receiver 28 for combining and separating the DDC_Data_sent and DDC_CClock signals to thereby achieve compatibility with the ports of the DVI connectors 30 and 30′.

An additional feature for accomplishing single fiber signal transmission involves the use of an optical multiplexer 68 in the electrooptic transmitter 26 and an optical demultiplexer 90 in the electrooptic receiver 28 for interfacing the single-fiber cable 24. Each of such devices, as disclosed, must be capable of combining (and separating) optical signals, one of which is bidirectional, of distinct optical frequencies and appropriately routing all of these signals to the appropriate elements of the electrooptic transmitter 26 and receiver 28 for further processing.

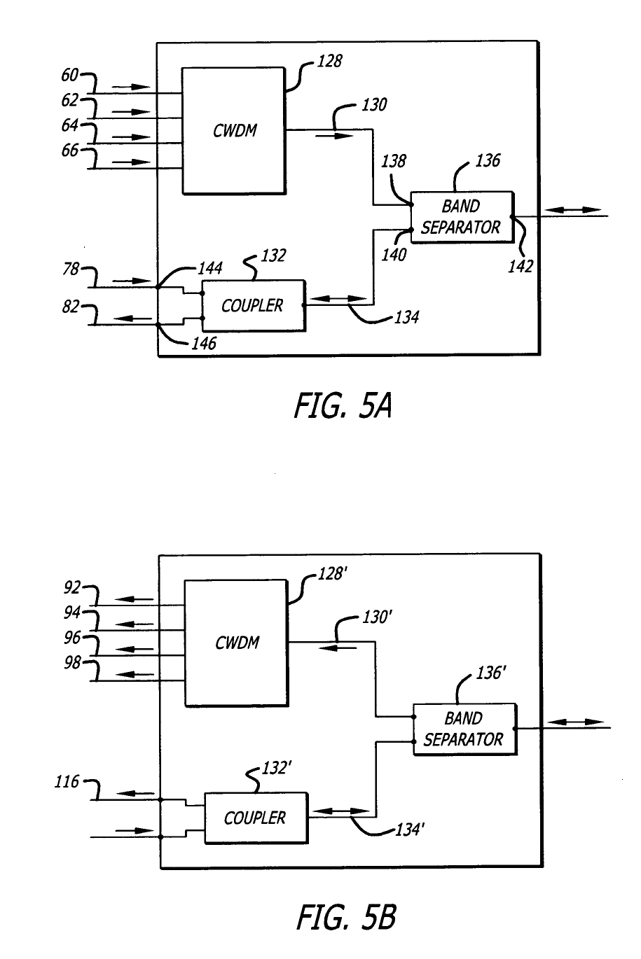

FIG. 5(a) is a schematic diagram of the optical multiplexer 68 of the electrooptic transmitter 26 while FIG. 5(b) is a schematic diagram of the optical demultiplexer 90 of the electrooptic receiver 28 of the invention. It should be noted that the hardware of the optical multiplexer 68 and that of the optical demultiplexer 90 are identical. Referring to the optical multiplexer 68, such device includes a coarse wavelength division multiplexer (“CWDM”) module 128 that receives the optical digital video signals transmitted over the optical fibers 60 through 66. As mentioned earlier, the CWDM module 128 is arranged to accommodate the distinct optical carrier frequencies transmitted over the fibers 60 through 66. The CWDM module 128 comprises appratus that is commonly employed in the telecommunications industry to combine optical signals of various center frequencies into a single signal that is transmitted over a single optical fiber 130.

The optical multiplexer 68 includes, in addition to the CWDM module 128, apparatus for processing the bidirectional transmission protocol signal DDC_Data both onto and out of the single-fiber cable 24. This is accomplished in part by the inclusion of a 2×1 broadband optical coupler 132 that receives an input signal (the multiplexed DDC_Data_sent and DDC_Clock signals) and transmits a signal at one end (the DDC_Data_received signal) from the electrooptic receiver 28 at the other end. It forwardly directs the serially-combined DDC_Data_sent and DDC_Clock signals over a fiber 134 while it reversely directs the DDC_Data_received signal, received over the same fiber, onto the optical fiber 82. The DDC_Data_received is subsequently applied to'the photodetector 84 of the electrical-to-optical converter circuit.

The fibers 130 (carrying the multiplexed digital video information) and 134 (carrying the bidirectional DDC_Data signal and the forwardly-directed DDC_Clock signal) are applied to a band separator 136. As mentioned earlier, the light sources 52 through 58 that provide the optical carriers of the digital video signals have distinct center frequencies that, in combination, define a frequency band that excludes the carrier frequency common to the light sources 76 and 761. The band separator 136 is arranged to restrict optical signals, regardless of direction of transmission, to input ports 138 and 140 in accordance with a predetermined frequency criterion while permitting through transmission of all signals at a common output output port 142. The frequency criterion of the band separator 136 is selected to distinguish the band of center frequencies of the light sources 52 through 58 from the light sources 76 (and 76′). As a result, the optical multiplexer 68 not only incorporates “conventional” CWDM functions but also provides a bidirectional pathway for transmission of protocol information. Two additional ports 144 and 146 for accommodating the bidirectional transmission protocol signal DDC_Data contribute to complete compatibility with the DVI connectors 30, 30′ so that greatly extended range of communication between a processor 10 and a display 14 is achieved at a cost that reflects the use of a minimal amount of optical fiber.

The operation of the optical demultiplexer illustrated in FIG. 5(b) is the opposite the above-described operation of the optical multiplexer of FIG. 5(a).

FIG. 6 is a schematic diagram of a directional logic circuit 80, 80′ in accordance with the invention. Such a circuit, as mentioned above, is essential to the integration of a fiber optic link that extends the range over which DVI connectors 30 and 30′ (and, therefore, the microprocessor 10 and the display device 14) can successfully communicate high speed real time video information in accordance with applicable DVI standards. The directional logic circuit 80, 80′, as mentioned earlier, splits a bidirectional electrical transmission protocol signal, DDC_Data into two single-directional electrical component signals (DDC_Data_sent, DDC_Data_received). By splitting the bidirectional electrical signal into two single-directional components, DDC_Data is made suitable for transmission over two optical fiber paths, one for sending and the other for receiving. Thereafter, the directional logic circuit 80 recombines the two components onto a single electrical conductor in such a way that the DVI standard and the physical limitations of existing DVI connectors requiring receipt and transmission of transmission protocol information through a single bidirectional port are met.

Referring to the internal arrangement of the circuit 80 (the operation and arrangement of the directional circuit 80′ are identical), a first node 148 is provided in an electrical conductor 150 that joins the bases of bipolar transistors 152 and 154 for receipt of an incoming DDC_Data_received signal sent from the DVI connector 30′. Each of the bipolar transistors is of the npn type with emitter grounded.

The collector side of the transistor 152 communicates with a conductor 156 having a node 158 in communication with the electrical conductor 42 that communicates with the bidirectional port of the DVI connector 30 that sends and receives the DDC_Data transmission protocol information signals. The collector side of the transistor 154 is connected to a circuit branch 160. A d.c. voltage source (e.g. +5 Vdc) is located at the remote end of the circuit-branch. A node 162 is intermediate the transistor 154 and the voltage source while a resistor 164 is located between the voltage source and the node 162.

In operation, the circuit comprising the circuit branch 160 and the transistor 154 functions to regulate the voltage level of the node 162. That is, the level of the node 162 is, for example, +5Vdc when the transistor 154 is not conducting or “off” and somewhat lower, due to the dissipation of energy as current flows through the resistor 164, when the transistor 154 is conducting or “on”.

A Driver Control signal is tapped from the node 162 onto a conductor 166. This signal provides one of the inputs to the logic gate 72 mentioned with reference to FIG. 2. The other input to the logic circuit comprises the DDC_Data_sent signal. The Driver Control signal is EXCLUSIVE OR'ed with the DDC_Data_sent signal at the logic gate 72. The output of the logic gate 72 is applied to the driver 74 that controls the output of the light source 76 which constitutes the forward transmission of transmission protocol information in the form of a digital optical signal.

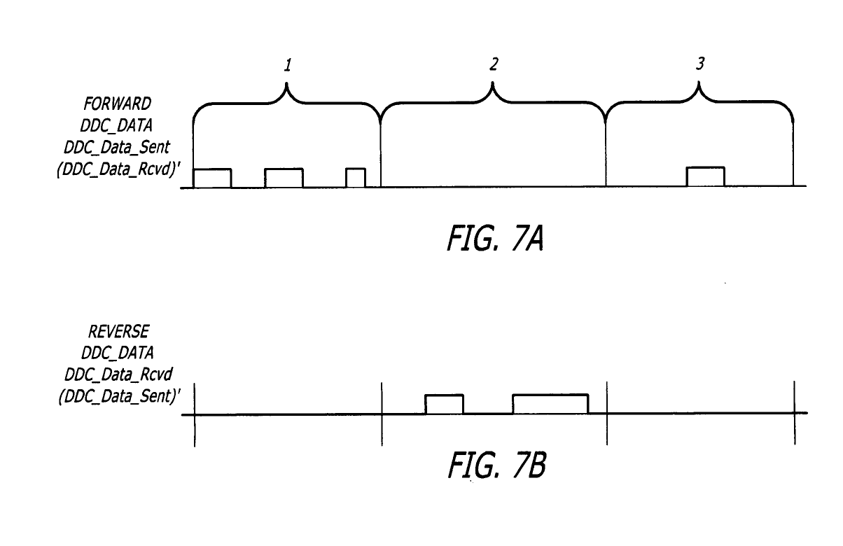

The Driver Control signal will be seen to be essential to the proper functioning of the system. The basic format of the bidirectional signal DDC_data is illustrated by the timing diagrams of FIGS. 7(a) and 7(b). FIG. 7(a) illustrates the forward transmission of DDC_Data while FIG. 7(b) illustrates the receipt of DDC_Data with respect to the DVI connector 30. (Note, the opposite situation exists with respect to the DVI connector 30′.) Periods “1” and “3” have been reserved or dedicated to transmission of data from the DVI connector 30 while period “2” is dedicated to receipt of data at the connector 30. (Note: the durations of periods 1, 2, 3, etc. are established and specified by the DVI standard.) It may be noted that forward DDC_Data transmissions are characterized by bi-level digital data separated by a dormant (low or logic “0” level) period during which bi-level DDC_Data is transmitted in the reverse direction.

Returning to the directional logic circuit 80 as illustrated in FIG. 6, such circuit is arranged so that DDC_Data_sent is applied, after having been multiplexed with the DDC_Clock signal, to the driver 74 during forward transmission periods such as periods 1 and 3 while reverse transmissions of DDC_Data (DDC_Data_received) are only received at the DVI connector 30 during receipt periods such as period 2. Such operation is achieved as follows. During a forward transmission of DDC_Data (e.g., period 1 or 3), the DDC_Data_received signal is low (period 2). The transistors 152 and 154, each of which acts as an inverter of such signal at the nodes 158 and 162, is off. As a result, the node 162 remains high (at the level of the +5 Vdc source) representing a logical “1”. This logic state is transmitted to the logic gate 72 as the Driver Control where it is EXCLUSIVE OR'ed with the DDC_Data_sent signal, resulting in the following:

| DDC_Data | DDC_Data_sent | Driver Control | Light Source |
|---|---|---|---|
| 1 | 1 | 1 | OFF |
| 0 | 0 | 1 | ON |

From the above, it can be seen that the light source 76 is responsive to the DDC_Data_sent signal (multiplexed with the DDC_Clock signal) during forward transmission of DDC_Data. (The light source 76 is arranged to output a light pulse in response to a logical “0” and to output no light in response to a logical “1”.)

During periods of reverse transmission of DDC_Data (e.g. period 2), the transistors 152 and 154 will be turned on by the arrival of logical “1's” in the DDC_Data-received signal at the node 148 and turned off by the arrival of logical “0′” in the reverse transmission. A logical “1” will turn on the transistors 152 and 154, driving the nodes 158 and 162 low. When this occurs, such a low level is seen at the DVI connector 30 and properly interpreted as the transmission of a logical “1” from the DVI connector 30′. When a logical “0” of the DDC_Data_received signal arrives at the node 148 during period 2, the transistor 152 is turned off and a logical “1” is seen at the node 158 that is properly interpreted by the DVI connector 30 as the transmission of a logical “0” from the DVI connector 30′.

In the latter case, the Driver Control signal is driven high as the transistor 154 is turned off by the arrival of a low level signal at the base of the transistor. In the situation illustrated in the prior table, a high level of the Driver Control signal permitted transmission of the DDC_Data_sent signal. Forward transmission of DDC_Data_received is, of course, to be avoided and it is prevented by the EXCLUSIVE OR'ing of the Driver Control signal with the inverted DDC_Data_received signal at the logic circuit 72. That is, Driver control is always the same as the inverted DDC_Data_received signal and so it can never pass through the logic circuit 72 to be applied to the driver 74 to trigger a forward transmission from the light sources 76. This mode of operation is summarized as follows:

| DDC_Data_received | DDC_Data | Driver Control | Light Source |
|---|---|---|---|
| 1 | 0 | 0 | OFF |
| 0 | 1 | 1 | OFF |

Thus, the directional logic circuit 80 (and 80′) permits the unmodified operation of existing DVI connectors 30, 30′ with greatly extended communication capabilities in a seamless fashion. Accordingly, the present invention provides apparatus for extending the range of transmission of high speed digital signals. By providing an arrangement in which signals are capable of transmission over long distances by means of a single optical fiber, one is assured that the potentially largest cost factor of a system employing the teachings of the invention will be minimized. Further, by relying upon a single optical fiber for transmission, the apparatus of the present invention is suitable for accessing and utilizing existing optical fiber transmission capacity, including presently-unused excess capacity.

By employing the teachings of the invention, one may realize the advantages of substantially extended range between a processor and display device, for example, without incurring the substantial investment and security risks associated with such alternative means as microwave links.

While the invention has been described with reference to its presently-preferred embodiment, it is not limited thereto. Rather this invention is limited only insofar as it is described by the following set of patent claims and includes within its scope all equivalents thereof.

What is claimed is:

1. Apparatus for generating video images on a display device arranged in accordance with a digital video standard comprising, in combination:
a) a processor for generating a plurality of digital electrical signals in accordance with said predetermined video standard, said plurality of digital electrical signals including a first transmission protocol signal;
b) a first connector, including a plurality of pins, for receiving and directing each of said digital electrical signals to a predetermined pin and for receiving a second digital electrical transmission protocol signal at a predetermined pin;
c) a second connector including a plurality of pins arranged to receive each of said digital electrical signals, direct each of said signals to a predetermined portion of a port of said display device and to receive said second digital electrical transmission protocol signal from said port of said display device and direct said transmission protocol signal to a predetermined pin of said second connector;
d) an electrical-to-optical converter circuit for receiving said digital electrical signals and generating a plurality of digital optical signals in response thereto and for receiving a digital optical signal and generating said second digital electrical transmission protocol signal in response thereto;
e) an optical-to-electrical converter circuit for receiving a plurality of digital optical signals and converting said signals to said plurality of digital electrical signals and for converting said second digital electrical transmission protocol signal to a digital optical signal;
f) an optical cable in optical communication with said electrical-to-optical converter and said optical-to-electrical converter; and
g) said optical cable including a single optical fiber for transmitting said optical signals between said electrical-to-optical converter and said optical-to-electrical converter.

2. Apparatus as defined in claim 1 wherein said electrical-to-optical converter circuit further includes:
a) a first branch for receiving a digital optical signal and converting said signal to said second digital electrical transmission protocol signal;
b) a second branch for receiving said first digital electrical transmission protocol signal and an electrical transmission protocol clock signal and for converting said signals to a single digital optical signal; and
c) a directional logic circuit in communication with said first connector and with said first and second branches for preventing retransmission of said second digital electrical transmission protocol signal onto said optical cable.

3. Apparatus as defined in claim 2 wherein said second branch of said electrical-to-optical circuit further includes:
a) a light source; and
b) said light source being controlled by the output of a logic gate; and
c) the inputs to said logic gate being said first transmission protocol signal and the inverse of said second transmission protocol signal.

4. Apparatus as defined in claim 3 wherein said logic gate comprises an EXCLUSIVE OR gate.

5. Apparatus as defined in claim 2 wherein said directional logic circuit includes:
a) a first node for receiving said second transmission protocol signal;
b) a second node for receiving said first transmission protocol signal and the inverse of said second transmission protocol signal; and
c) a third node for receiving the inverse of said second transmission protocol signal.

6. Apparatus as defined in claim 5 wherein the inputs to said EXCLUSIVE OR gate comprise the voltage potentials at said second and third nodes.

7. Apparatus as defined in claim 1 wherein said plurality of electrical signals additionally comprise red, blue and green information.

8. Apparatus as defined in claim 1 wherein said plurality of electrical signals additional comprises a pixel clock.

9. Apparatus as defined in claim 1 wherein said optical-to-electrical converter circuit further includes:
a) a first branch for receiving a digital optical signal and converting said signal to said first digital electrical transmission protocol signal and to an electrical transmission protocol clock;
b) a second branch for receiving said second digital electrical transmission protocol signal and converting said signal to a digital optical signal; and
c) a directional logic circuit in communication with said second connector and with said first and second branches for preventing retransmission of said first digital electrical transmission protocol signal onto said optical cable.

10. Apparatus as defined in claim 9 wherein said second branch of said electrical-to-optical circuit further includes:
a) a light source; and
b) said light source being controlled by the output of a logic gate; and
c) the inputs to said logic gate being said second transmission protocol signal and the inverse of said first digital electrical transmission protocol signal.

11. Apparatus as defined in claim 10 wherein said logic gate comprises an EXCLUSIVE OR gate.

12. Apparatus as defined in claim 9 wherein said directional logic circuit includes:
a) a first node for receiving said first transmission protocol signal;
b) a second node for receiving said second digital electrical transmission protocol signal and the inverse of said first digital electrical transmission protocol signal; and
c) a third node for receiving the inverse of said first digital electrical transmission protocol signal.

13. Apparatus as defined in claim 12 wherein the inputs to said EXCLUSIVE OR gate comprise the voltage potentials at said second and third nodes.

14. Apparatus as defined in claim 1 further characterized in that:
a) said plurality of digital electrical signals generated by said processor includes an electrical transmission protocol clock signal; and
b) said electrical-to-optical converter circuit includes an electrical multiplexer for serially combining said first electrical transmission protocol digital electrical signal and said electrical transmission protocol clock signal.

15. Apparatus as defined in claim 14 further including a light source, said light source being responsive to said serially combined first electrical transmission protocol signal and said electrical transmission protocol clock signal to output a first digital optical transmission protocol signal.

16. Apparatus as defined in claim 2 wherein said optical-to-electrical converter circuit further includes:
a) a photodetector for converting said first digital optical transmission protocol signal to a serial combination of said first digital electrical transmission protocol signal and said electrical transmission protocol clock signal; and
b) an electrical demultiplexer for separating said serial combination into said first digital electrical transmission protocol signal and said electrical transmission protocol clock signal.

17. Apparatus as defined in claim 1 wherein said electrical-to-optical converter circuit is further characterized in that:
a) said plurality of digital electrical signals includes a plurality of digital electrical video signals;
b) each of said digital electrical video signals is arranged to modulate the output of one of a corresponding plurality of light sources;
c) each of said corresponding plurality of light sources is arranged to emit light of a different center wavelength;
d) said center wavelengths of said corresponding plurality of light sources defining a frequency band; and
e) the center frequency of said light source for outputting said first transmission digital optical transmission protocol signal is outside said frequency band.

18. Apparatus as defined in claim 1 wherein said optical-to-electrical converter circuit further includes:
a) a light source, said light source being responsive to said second electrical transmission protocol signal to output a second digital optical transmission protocol signal; and
b) said light source is arranged to output light of the same center frequency as said light for outputting a first digital optical transmission protocol signal.

19. Apparatus as defined in claim 18 wherein said electrical-to-optical converter circuit further includes:
a) an optical multiplexer;
b) said optical multiplexer being arranged to receive said plurality of digital optical video signals from said plurality of light sources of said frequency band, said first digital optical transmission protocol signal from said light source outside said frequency band and said second digital optical transmission protocol signal from said optical cable;
c) said optical multiplexer providing a single optical signal onto said optical cable that comprises said plurality of digital optical video signals and said first digital optical transmission protocol signal; and
d) said optical multiplexer providing said second digital optical transmission protocol signal to a photodetector for generating said second digital electrical transmission protocol signal.

20. Apparatus as defined in claim 18 wherein said optical-to-electrical converter circuit further includes:
a) an optical demultiplexer;
b) said optical demultiplexer being arranged to receive said second digital optical transmission protocol signal and an optical signal that includes said plurality of digital optical video signals and said first digital optical transmission protocol signal from said optical cable;
c) said optical demultiplexer providing said second digital optical transmission protocol signal onto said optical cable and said plurality of optical video signals to a plurality of photodetectors for generating said plurality of digital electrical video signals; and
d) said optical demultiplexer providing said first digital optical transmission protocol signal to a photodetector for generating said serially combined first digital electrical transmission protocol signal and electrical transmission protocol clock signal.

21. Apparatus for communication of a bidirectional digital electrical signal, comprising sequential forward and reverse transmissions, between a bidirectional port of a first device and a bidirectional port of a second device, and an associated electrical clock signal between a clock port of said first device and a clock port of said second device, said first and second devices being remote from one another, said apparatus comprising, in combination:
a) an electrical-to-optical converter circuit for receiving a forward digital electrical signal and said electrical clock signal and generating a forward digital optical signal in response thereto and for receiving a reverse digital optical signal and generating a reverse digital electrical signal in response thereto;
b) an optical-to-electrical converter circuit for receiving said forward digital optical signal and converting said signal to said forward digital electrical signal and said electrical clock signal and for converting said reverse digital electrical signal to said reverse digital optical signal;
c) an optical cable in optical communication with said electrical-to-optical converter and said optical-to-electrical converter; and
d) said optical cable comprising a single optical fiber for transmitting said optical signals between said electrical-to-optical converter and said optical-to-electrical converter.

22. Apparatus as defined in claim 21 wherein said electrical-to-optical converter circuit further includes:
a) a first branch for receiving said reverse digital optical signal and converting said signal to said reverse digital electrical signal;
b) a second branch for receiving said forward digital electrical signal and said electrical clock signal and converting said signals to said forward digital optical signal; and
c) a directional logic circuit in communication with said first connector and with said first and second branches for preventing retransmission of said reverse digital electrical transmission signal onto said optical cable.

23. Apparatus as defined in claim 22 wherein said second branch of said electrical-to-optical circuit further includes:
a) a light source; and
b) said light source being controlled by the output of a logic gate; and
c) the inputs to said logic gate being said forward digital electrical signal and the inverse of said reverse digital electrical signal.

24. Apparatus as defined in claim 23 wherein said logic gate comprises an EXCLUSIVE OR gate.

25. Apparatus as defined in claim 24 wherein said directional logic circuit includes:
a) a first node for receiving said reverse digital electrical signal;
b) a second node for receiving said forward digital electrical signal and the inverse of said reverse digital electrical signal and
c) a third node for receiving the inverse of said reverse digital electrical signal.

26. Apparatus as defined in claim 25 wherein the inputs to said EXCLUSIVE OR gate comprise the values at said second and third nodes.

27. Apparatus as defined in claim 21 wherein said optical-to-electrical converter circuit further includes:
a) a first branch for receiving said forward digital optical signal and converting said signal to said forward digital electrical signal and said electrical clock signal;
b) a second branch for receiving said reverse digital electrical signal and converting said signal to said reverse digital optical signal; and
c) a directional logic circuit in communication with said second connector and with said first and second branches for preventing retransmission of said forward digital electrical signal onto said optical cable.

28. Apparatus as defined in claim 27 wherein said second branch of said electrical-to-optical circuit further includes:
a) a light source; and
b) said light source being controlled by the output of a logic gate; and
c) the inputs to said logic gate being said reverse digital electrical signal and the inverse of said forward digital electrical signal.

29. Apparatus as defined in claim 28 wherein said logic gate comprises an EXCLUSIVE OR gate.

30. Apparatus as defined in claim 29 wherein said directional logic circuit includes:
a) a first node for receiving said forward digital electrical signal;
b) a second node for receiving said reverse digital electrical signal and the inverse of said forward digital electrical signal; and
c) a third node for receiving the inverse of said forward digital electrical signal.

31. Apparatus as defined in claim 30 wherein the inputs to said EXCLUSIVE OR gate comprise the voltage potentials at said second and third nodes.

32. Apparatus as defined in claim 21 wherein said electrical-to-optical converter circuit further includes an electrical multiplexer for serially combining said forward digital electrical signal and said electrical clock signal.

33. Apparatus as defined in claim 32 further including a light source, said light source being responsive to said serially combined signal to output said forward digital optical signal.

34. Apparatus as defined in claim 21 wherein said optical-to-electrical converter circuit further includes:
a) a photodetector for converting said forward digital optical signal to an electrical signal comprising a serial combination of said forward digital electrical signal and said electrical clock signal; and
b) an electrical demultiplexer for separating said electrical signal comprising a serial combination of said forward digital electrical signal and said electrical clock signal into said forward digital electrical signal and said electrical clock signal.
